(19) United States
(12) Patent Application Publication
(10) Pub. No.: US 2021/0178660 A1
(43) Pub. Date: Jun. 17, 2021

(54) 3D printing of crystalline polymeric material

(71) Applicant: INTAMSYS TECHNOLOGY CO., LTD., Dongguan, Guangdong (CN)

(72) Inventors: Xianming Dong, Dongguan, Guangdong (CN); Chengchao Han, Dongguan, Guangdong (CN); Shaowu Qin, Dongguan, Guangdong (CN)

(21) Appl. No.: 16/762,503

(22) PCT Filed: Dec. 4, 2017
(86) PCT No.: PCT/CN2017/114425

§ 371 Date: May 8, 2020

(51) Int. Cl. B29C 64/118; B33Y 10/00; B33Y 30/00; B29C 64/295; B29C 64/209

(52) U.S. Cl. CPC B29C 64/118; B33Y 10/00; B29K 2995/0041; B29C 64/295; B29C 64/209; B33Y 30/00

(57) ABSTRACT

A process of 3D printing of crystalline polymeric material includes the steps of (a) heating a print head to melt a first crystalline polymeric material therein; (b) activating the print head to print a layer until a molten, layered print pattern is deposited; (c) cooling the molten, layered print pattern to form a solid print pattern having a plurality of amorphous regions; (d) heat-treating the solid print pattern; and (e) repeating steps (b), (c), and (d) until a 3D-printed object having a layered print pattern is created. A print pattern unit includes at least one print pattern layer.

### BACKGROUND OF THE INVENTION

### 1. Field of the Invention

The invention relates to three-dimensional (3D) printing and more particularly to a process of 3D printing of crystalline polymeric material and a 3D printer thereof.

### 2. Description of Related Art

3D printing processes are widely employed in many applications due to advancement of 3D printing technologies. A typical 3D-printing process comprises the steps of creating a digital 3D model with a computer-aided design (CAD) package, converts the 3D model into a series of thin layers and produces a file containing instructions tailored to a specific type of 3D printer, and printing the file with 3D printing client software which loads the file and uses it to instruct the 3D printer during the 3D printing process. As a result, a 3D object is created.

Polymeric materials for 3D printing are crystalline polymeric materials or non-crystalline polymeric materials. But crystalline polymeric materials comprise crystalline monomers and non-crystalline monomers elements due to incomplete crystallization. The most-commonly used 3D-printing process is a material extrusion technique called fused deposition modeling (FDM). FDM is a 3D printing process that uses a continuous filament of a thermoplastic material. Filament is fed from a large coil through a moving, heated print head, and is deposited on the growing work. The print head is moved to define the printed shape. Usually the head moves in two dimensions to deposit material one horizontal plane (or layer) at a time. The work or the print head is then moved vertically by a small amount to begin a new layer. For bonding a layer to a next layer, the material is required to diffuse in the molecular dimension between the layers, thereby melting the layers. In the melting process, a print head of a 3D printer is required to transfer sufficient heat to crystalline polymeric materials for melting same or cause amorphous polymeric materials to be in a viscous flow state.

Regarding the typical 3D printing technologies, it involves increasing room temperature, i.e., increasing printing temperature, to additionally transfer heat to the print head, thereby bonding layers. However, the conventional art is disadvantageous because it is very difficult, the elevated room temperature may cause mechanisms and circuitry of the 3D printer to malfunction, reliability is decreased greatly, and useful life of the 3D printer is shortened greatly. In addition, degree of crystallinity of a 3D-printed object is adversely increased, thereby rendering the 3D-printed object to be more brittle and less flexible.

Thus, the need for improvement still exists.

### SUMMARY OF THE INVENTION

The invention has been made in an effort to solve the problems of the conventional art including decreased reliability and shortened useful life of a 3D printer due to elevated room temperature by providing a process of 3D printing of crystalline polymeric material and a 3D printer thereof having novel and nonobvious characteristics.

To achieve above and other objects of the invention, the invention provides a process of 3D printing of crystalline polymeric material, comprising (a) heating a print head to melt a first crystalline polymeric material therein; (b) activating the print head to print a layer until a molten, layered print pattern is deposited; (c) cooling the molten, layered print pattern to form a solid print pattern having a plurality of amorphous regions; (d) heat-treating the solid print pattern; and (e) repeating steps (b), (c), and (d) until a 3D-printed object having a layered print pattern is created; wherein a print pattern unit includes at least one print pattern layer.

Preferably, the print pattern unit is made of amorphous polymeric material.

Preferably, the heat-treating temperature is at a glass transition region of the amorphous polymeric material of the print pattern unit.

Preferably, the heat-treating temperature is greater than the glass transition temperature of the amorphous polymeric material of the print pattern unit but less than a crystallization temperature of the amorphous polymeric material of the print pattern unit.

Preferably, a thickness of the print pattern unit is less than 2 mm.

Preferably, the print pattern unit is made of a second crystalline polymeric material having a plurality of amorphous regions.

Preferably, the first crystalline polymeric material is at least one of poly-ether-ether-ketone (PEEK) and a composite material thereof, a polyamide (PA) and a composite material thereof, and polyethylene terephthalate (PET) and a composite material thereof.

The 3D printing process of the invention has the following advantageous effects in comparison with the prior art: by cooling the molten print pattern it is possible of depositing a solid print pattern of amorphous polymeric material, i.e., quickly cooling the molten print pattern so that it may not crystallize or partially crystallize, thereby forming a layered print pattern having amorphous regions. In comparison with the print pattern of crystalline polymeric material, when a printing step is performed on a top of the cooled print pattern for depositing a layer, heat supplied by the print head does not damage the crystalline structure and ensures a melting of the crystalline polymeric material. It is only required that the amorphous polymeric material of the cooled print pattern be in a viscous flow state so that two adjacent layers can be bonded together. And in turn, it greatly decreases the energy for bonding the layers of the print pattern. Further, it greatly decreases print head temperature and printing time. Furthermore, the flexibility of the 3D-printed object is greatly increased due to great decrease of the degree of crystallinity. In addition, each print pattern unit is heat-treated, thereby eliminating stress between layers of the print pattern unit and stress of each print pattern in the printing process. This can prevent the 3D-printed object from being deformed due to stress accumulation in the object. As a result, a precise shape of the 3D-printed object without bending or breakage is obtained.

The invention further provides a 3D printer comprising a moving platform; a print head; a printing platform; a cooling device; a print head heating device; and a print pattern heating device; wherein the print head heating device is disposed on a top of the print head and operatively connected a position between the print head and the moving platform which is configured to move the print head on the printing platform along a predetermined path; wherein the cooling device is disposed above the printing platform for cooling a print pattern deposited on the printing platform; and wherein the print pattern heating device is disposed above the printing platform for heating the cooled print pattern deposited on the printing platform.

Preferably, the print pattern heating device is implemented as an air heater, an infrared heater, a laser heater, or a combination thereof.

Preferably, the print pattern heating device and the cooling device are rotatably disposed on two sides of the print head respectively and are at the same elevation.

The 3D printer of the invention has the following advantageous effects in comparison with the prior art: in the 3D printer of the invention, a closed room for increasing temperature is not required. Further, temperature of the print head is not required to increase. Thus, both mechanisms and circuitry of the 3D printer are prevented from being malfunctioned. Furthermore, a useful life of the 3D printer is prolonged greatly. Energy consumed by the 3D printer in printing is greatly decreased. In addition, the manufacturing cost of the 3D printer is decreased greatly.

The above and other objects, features and advantages of the invention will become apparent from the following detailed description taken with the accompanying drawings.

### BRIEF DESCRIPTION OF THE DRAWINGS

FIG. 1 is a flow chart of a process of 3D printing of crystalline polymeric material according to a preferred embodiment of the invention;

FIG. 2 schematically depicts a 3D printer according to a preferred embodiment of the invention in a printing operation; and

FIG. 3 schematically depicts the 3D printer in a heat-treating operation.

### DETAILED DESCRIPTION OF THE INVENTION

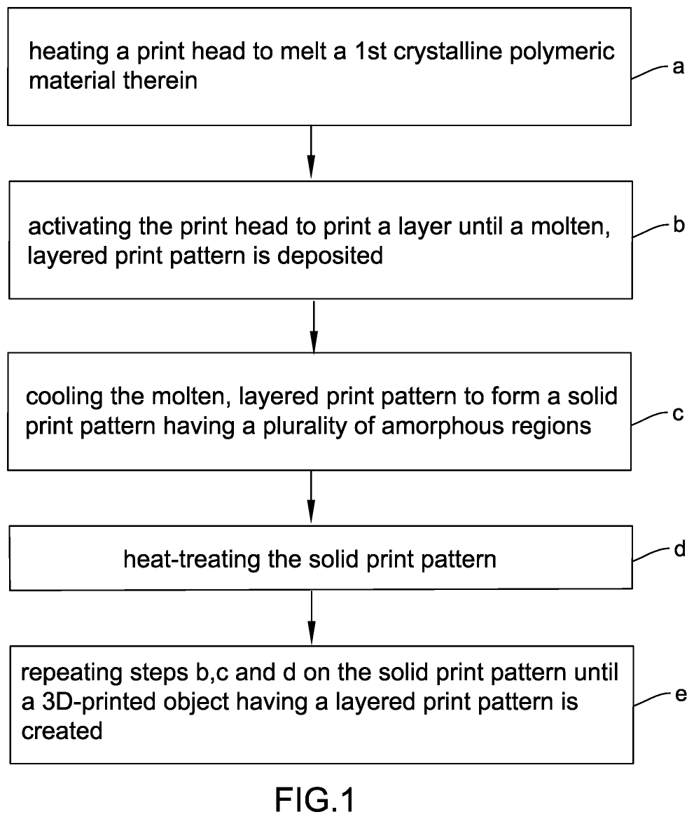

Referring to FIG. 1, a flow chart of a process of 3D printing of crystalline polymeric material of a preferred embodiment of the invention is illustrated. The process comprises the steps of (a) heating a print head to melt a first crystalline polymeric material therein, (b) activating the print head to print a layer until a molten, layered print pattern is deposited, (c) cooling the molten, layered print pattern to form a solid print pattern having a plurality of amorphous regions, (d) heat-treating the solid print pattern, and (e) repeating steps (b), (c), and (d) until a 3D-printed object having a layered print pattern is created, i.e., successively adding material layer by layer. A print pattern unit includes at least one print pattern layer.

In one embodiment, the print pattern unit includes a plurality of print pattern layers, and the print pattern layers are layered.

In one embodiment, the process further comprises obtaining a digital 3D model. The print head successively adds a material layer by layer on the print pattern based on the 3D model. As a result, a 3D-printed object is created.

In one embodiment, the cooling speed is very quick and thus the molten crystalline polymeric material may not completely crystallize, thereby forming an amorphous polymeric material. And in turn, the print pattern unit is a solid print pattern of amorphous polymeric material. After each layer of the print pattern has been cooled, it becomes an amorphous polymeric material. In comparison with the crystalline polymeric material, it does not damage the polymeric material, lowers energy for bonding two adjacent print patterns, and is capable of creating a 3D-printed object having good bonding force, and improves quality of the 3D-printed objects.

In other embodiments, the cooling speed and the cooling temperature may cause the molten crystalline polymeric material to not completely crystalize and thus the cooled print pattern may form a second crystalline polymeric material having amorphous regions.

Thus, it is possible of creating 3D-printed objects having different degrees of crystallinity by changing the cooling speed and the cooling temperature of a cooling device.

In one embodiment, for the print patterns of the print pattern unit being amorphous polymeric material, i.e., the print pattern unit being amorphous polymeric material, the heat-treating temperature is in the glass transition range. It not only increases dynamics of the molecular chain segment but also prevents the second crystallization from occurring, sufficiently releases the stress, and increase precision of the 3D-printed object. The glass transition of the amorphous polymeric material occurs between a glassy state and an elastomeric state and is within a temperature range. Specifically, it occurs at a predetermined temperature of the temperature range. The glass transition region comprises a temperature range for the amorphous polymeric material being between the glassy state and the elastomeric state. The heat-treating temperature is greater than the glass transition temperature of the amorphous polymeric material but less than the crystallization temperature of the amorphous polymeric material. Crystallization occurrence in the heat treatment can be avoided by increasing the heat-treating temperature to a desired temperature. As a result, the precision of the 3D-printed object is greatly increased.

In one embodiment, the print pattern unit is solid second crystalline polymeric material comprising amorphous regions. The heat-treating temperature is at a glass transition region of the second crystalline polymeric material. Alternatively, the heat-treating temperature is greater than the glass transition temperature of the second crystalline polymeric material but less than the crystallization temperature of the second crystalline polymeric material. This ensures that the heat-treating temperature is less than the crystallization temperature of the second crystalline polymeric material. As a result, crystallization occurrence in the heat treatment can be avoided.

In above embodiments, the heat treatment not only increases dynamics of the molecular chain segment but also prevents deformation and decreased flexibility of the object due to crystallization from occurring, sufficiently releases the stress between the print patterns and the stress of each print pattern, decreases the accumulation of stress during the printing, and ensures a correct size of the object. For preventing deformation of the object being printed from occurring in the heat treatment, thickness of the print pattern unit is required to be less than 2 mm so that the stress can be eliminated, changes of the molecular conformation do not deform the layered print pattern in the Z-axis, and prevents the print pattern unit from being deformed in the heat treatment. This process involves both heat treatment and printing at the same time. Thus, stress does not accumulate in the object being printed and the created object has a precise shape.

For the thickness of the print pattern unit greater than 2 mm, its stress may accumulate significantly, the changes of the molecular conformation may deform the layered print pattern, and adversely affect the shape of the object.

In one embodiment, the first crystalline polymeric material is at least one of poly-ether-ether-ketone (PEEK) and a composite material thereof, a polyamide (PA) and a composite material thereof, and polyethylene terephthalate (PET) and a composite material thereof. For creating objects having different degrees of crystallinity in the 3D printing of crystalline polymeric material, both the cooling speed and the cooling temperature can be adjusted appropriately to prevent crystallization from occurring in the first crystalline polymeric material in cooling. Alternatively, no crystallization occurs both amorphous and crystalline polymeric materials, thereby form a second crystalline polymeric material having different degrees of crystallinity.

For preventing the cooling step from adversely affecting the heat treatment and vice versa, after depositing a print pattern having a plurality of layers after the printing and cooling steps it is possible of heat-treating the print pattern having layers to eliminate stress of the layers of the print pattern. Thereafter, another print pattern having layers is deposited by repeating the printing and cooling steps and the print pattern is heat-treated. Alternatively, a heat treatment is performed on each formed print pattern. These successive steps of printing, cooling and heat-treating not only increase quality of the created object but also simplify subsequent steps required for treating the created object.

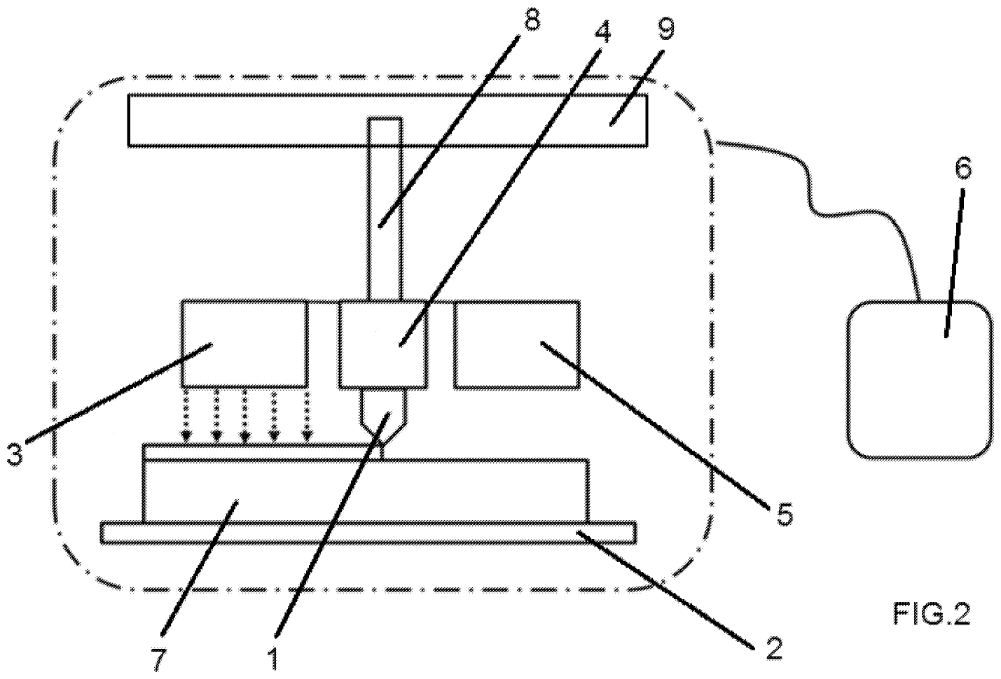

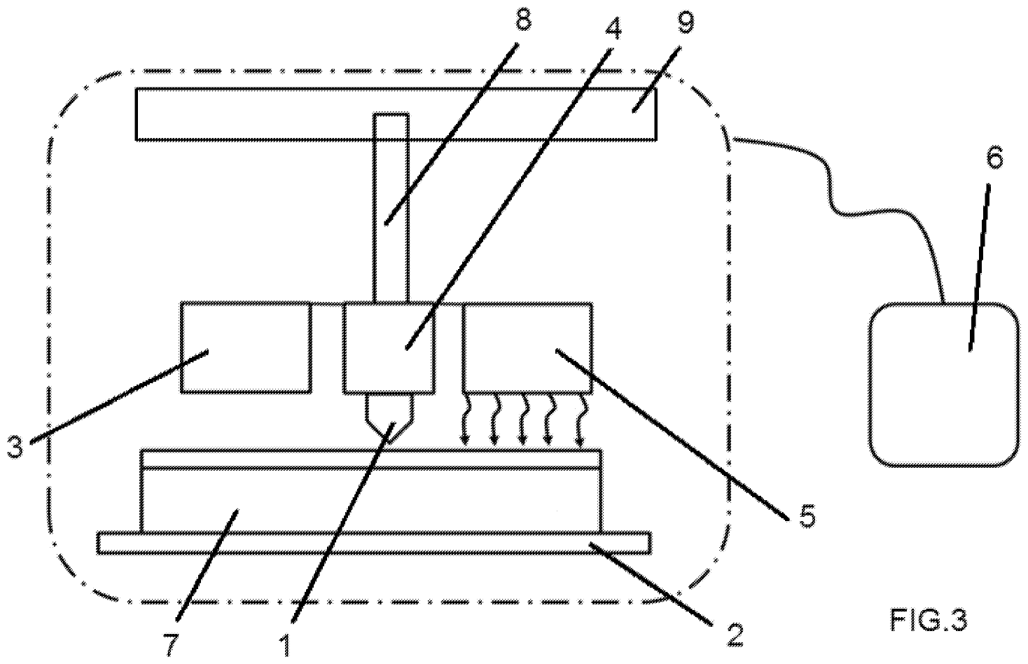

Referring to FIGS. 2 and 3, a 3D printer of a preferred embodiment of the invention for the process of 3D printing of crystalline polymeric material is shown. The 3D printer comprises a moving platform 9, a print head 1, a printing platform 2, a cooling device 3, a print head heating device 4, and a print pattern heating device 5.

The print head heating device 4 is disposed on a top of the print head 1 and operatively connected a position between the print head 1 and the moving platform 9 which is used to move the print head 1 on the printing platform 2 along a predetermined path. The cooling device 3 is disposed above the printing platform 2 for cooling a print pattern deposited on the printing platform 2. The print pattern heating device 5 is disposed above the printing platform 2 for heating the cooled print pattern deposited on the printing platform 2. The print head heating device 4 is used to melt a filament of crystalline polymeric material 8 so that the print head 1 may deposit a molten print pattern on the printing platform 2. A 3D-printed object 7 is formed by the layered print pattern.

In the embodiment of FIG. 1, the cooling device 3 may spray cooling air on the print pattern being deposited on the printing platform 2.

Alternatively, in other embodiments, the cooling device 3 may spray cooling gas (e.g., nitrogen or the like) on the print pattern being deposited on the printing platform 2.

In the embodiment of FIGS. 2 and 3, the print pattern heating device 5 may spray cooling air on the print pattern being deposited on the printing platform 2.

Alternatively, in other embodiments, the print pattern heating device 5 is implemented as an air heater, an infrared heater, a laser heater, or a combination thereof.

In the embodiment, the print pattern heating device 5 and the cooling device 3 are rotatably mounted on two sides of the print head 1 respectively and are at the same elevation. The cooling device 3 may rotate to spray sufficient cooling medium to the print pattern being deposited on the printing platform 2. The print pattern heating device 5 may rotate to provide sufficient heat to the print pattern being deposited on the printing platform 2. As a result, a quality 3D-printed object is created.

As shown in FIGS. 2 and 3, the 3D printer is further provided with a controller 6 comprising a print head heating device control unit, a cooling device control unit, and a print pattern heating device control unit. The print head heating device control unit is used to control temperature of the print head 1 so as to appropriately adjust the temperature of the print head 1 based on different degrees of crystallinity of the first crystalline polymeric material, thereby melting the first crystalline polymeric material. The cooling device control unit is used to control both the spraying speed and the temperature of the cooling air. The print pattern heating device control unit is used to control both the spraying speed and the temperature of the hot air sprayed on the print pattern unit by the print pattern heating device.

A process of 3D printing of crystalline polymeric material of another preferred embodiment of the invention comprises the steps of (i) creating a digital 3D model (or a computer-aided design (CAD) file) with a CAD package via a 3D scanner, (ii) executing software (called slicer) to convert the 3D model to specific instructions for the 3D printer, (iii) activating a print head heating device to heat a print head for melting a crystalline polymeric material (e.g., PEEK) in the print head, (iv) activating the moving platform to move the print head to along the printing platform for adding material together, layer by layer, until a molten print pattern is deposited, (v) activating the cooling device to spray cooling air to the molten print pattern on the printing platform, (vi) not crystallizing or partially crystallizing the molten print pattern to form a layered print pattern having amorphous regions, and (vii) repeating steps (iv) to (vi) until a 3D-printed object is created. In the embodiment, thickness of each layer of the print pattern is 0.3 mm. A heat treatment is performed on two bonded print pattern layers.

Alternatively, in other embodiments, each layer of the print pattern may be less than 0.3 mm. Thus, a heat treatment is performed on more than two bonded print pattern layers. In short, the heat treatment is applicable to any layered print pattern having a thickness less than 2 mm.

The process of 3D printing of crystalline polymeric material of another preferred embodiment of the invention is characterized below. By cooling the molten print pattern it is possible of depositing a solid print pattern of amorphous polymeric material, i.e., quickly cooling the molten print pattern so that it may not crystallize or partially crystallize, thereby forming a layered print pattern having amorphous regions. In comparison with the print pattern of crystalline polymeric material, when a printing step is performed on a top of the cooled print pattern for depositing a layer, heat supplied by the print head does not damage the crystalline structure and ensures a melting of the crystalline polymeric material. It is only required that the amorphous polymeric material of the cooled print pattern be in a viscous flow state so that two adjacent layers can be bonded together. And in turn, it greatly decreases the energy for bonding the layers of the print pattern. Further, it greatly decreases print head temperature and printing time. Furthermore, the flexibility of the 3D-printed object is greatly increased due to great decrease of the degree of crystallinity. In addition, each print pattern unit is heat-treated, thereby eliminating stress between layers of the print pattern unit and stress of each print pattern in the printing process. This can prevent the 3D-printed object from being deformed due to stress accumulation in the object. As a result, a precise shape of the 3D-printed object without bending or breakage is obtained.

The invention has the following advantageous effects in comparison with the prior art: in the 3D printer of the embodiment, a closed room for increasing temperature is not required. Further, temperature of the print head is not required to increase. Thus, both mechanisms and circuitry of the 3D printer are prevented from being malfunctioned. Furthermore, a useful life of the 3D printer is prolonged greatly. Energy consumed by the 3D printer in printing is greatly decreased. In addition, the manufacturing cost of the 3D printer is decreased greatly.

While the invention has been described in terms of preferred embodiments, those skilled in the art will recognize that the invention can be practiced with modifications within the spirit and scope of the appended claims.

What is claimed is:

1. A process of 3D printing of crystalline polymeric material, comprising:
(a) heating a print head to melt a first crystalline polymeric material therein;
(b) activating the print head to print a layer until a molten, layered print pattern is deposited;
(c) cooling the molten, layered print pattern to form a solid print pattern having a plurality of amorphous regions;
(d) heat-treating the solid print pattern; and
(e) repeating steps (b), (c), and (d) until a 3D-printed object having a layered print pattern is created;
wherein a print pattern unit includes at least one print pattern layer.

2. The process of claim 1, wherein the print pattern unit is made of amorphous polymeric material.

3. The process of claim 2, wherein the heat-treating temperature is at a glass transition region of the amorphous polymeric material of the print pattern unit.

4. The process of claim 2, wherein the heat-treating temperature is greater than the glass transition temperature of the amorphous polymeric material of the print pattern unit but less than a crystallization temperature of the amorphous polymeric material of the print pattern unit.

5. The process of claim 1, wherein a thickness of the print pattern unit is less than 2 mm.

6. The process of claim 1, wherein the print pattern unit is made of a second crystalline polymeric material having a plurality of amorphous regions.

7. The process of claim 1, wherein the first crystalline polymeric material is at least one of poly-ether-ether-ketone (PEEK) and a composite material thereof, a polyamide (PA) and a composite material thereof, and polyethylene terephthalate (PET) and a composite material thereof.

8. A 3D printer, comprising:
a moving platform;
a print head;
a printing platform;
a cooling device;
a print head heating device; and
a print pattern heating device;
wherein the print head heating device is disposed on a top of the print head and operatively connected a position between the print head and the moving platform which is configured to move the print head on the printing platform along a predetermined path;
wherein the cooling device is disposed above the printing platform for cooling a print pattern deposited on the printing platform; and
wherein the print pattern heating device is disposed above the printing platform for heating the cooled print pattern deposited on the printing platform.

9. The 3D printer of claim 8, wherein the print pattern heating device is implemented as an air heater, an infrared heater, a laser heater, or a combination thereof.

10. The 3D printer of claim 8, wherein the print pattern heating device and the cooling device are rotatably disposed on two sides of the print head respectively and are at the same elevation.
